(19) United States
(12) Patent Application Publication
(10) Pub. No.: US 2014/0246298 A1
(43) Pub. Date: Sep. 4, 2014

(54) HIGH VOLTAGE SWITCHING DEVICE

(71) Applicant: ABB Technology AG, Zurich (CH)

(72) Inventors: Ennio ERRICO, Fornovo San Giovanni (BG) (IT); Roberto MINGIARDI, Lodi (IT)

(73) Assignee: ABB Technology AG, Zurich (CH)

(21) Appl. No.: 14/190,410

(22) Filed: Feb. 26, 2014

(30) Foreign Application Priority Data
Mar. 1, 2013 (EP) 13157477.4

(51) Int. Cl. H01H 31/02; H01H 1/06

(52) U.S. Cl. CPC H01H 31/026; H01H 1/06
USPC 200/48 R

(57) ABSTRACT

An exemplary HV switching device includes a casing having at least a first fixed contact and a second fixed contact that are spaced apart from each other and can be connected to two corresponding power terminals. A first movable contact and a second movable contact are spaced apart from each other and actuated for coupling the first fixed contact and the second fixed contact, respectively. At least one of the first fixed contact and first movable contact has a shape for coupling the first movable contact to the first fixed contact in at least a first coupling position and a second coupling position which are spaced apart, and at least one of the second fixed contact and second movable contact has a shape for coupling the second movable contact to the second fixed contact in at least a third coupling position and a fourth coupling position which are spaced apart.

### RELATED APPLICATION(S)

This application claims priority under 35 U.S.C. 119 to European application No. 13157477.4 filed on Mar. 1, 2013 in Europe, the content of which is hereby incorporated by reference in its entirety.

### FIELD

The present disclosure relates to a high voltage (hereinafter “HV”) switching device, e.g., for applications with rated voltage above 1 kV.

### BACKGROUND INFORMATION

The use of switching or switchgear devices, such as disconnectors, earthing switches, combined disconnector-earthing switch devices, or the like is known in the art.

These devices have a casing inside which there are provided one or more fixed contacts and corresponding movable contacts; the movable contacts, when actuated, electrically engage or disengage each with/from an associated fixed contact so as to realize desired circuital configurations of the electrical network along which the switching device is installed.

In this way, and depending on the specific applications, it is possible for example to electrically feed or disconnect simultaneously or in alternative, one or more branches of a circuit and/or loads connected to the switching device, as well as to connect such branches or loads to ground potential.

Over the years these devices have been proposed according to various solutions meant to achieve an optimum balance between capabilities to perform the specified performances and to reduce manufacturing and installation costs, as well as space occupation.

One example of such known devices is for example described in patent document EP1121738, wherein a combined disconnector and earthing switch device is used in a more complex hybrid switchgear device.

For example, the combined device therein disclosed includes one or more movable contacts which have the form of a knife or blade and are mounted rotating on a shaft; the blade- or knife-shaped movable contacts couple each with a corresponding fixed contact so as to realize a plurality of desired circuital configurations.

Although such advanced and effective devices allow performing properly all specified functions with a high flexibility of combinations, customers always specify devices which are highly performing and more compact in order to further save material costs and to fit smart substation designs, such as mobile substations.

### SUMMARY

A high voltage (HV) switching device is disclosed, comprising: a casing including at least a first fixed contact and a second fixed contact which are spaced apart and are configured to be connected to two corresponding power terminals; a first movable contact and a second movable contact which are spaced apart and configured to be actuated for coupling with said first fixed contact and said second fixed contact, respectively, wherein at least one of said first fixed contact and first movable contact has a shape for coupling said first fixed contact with the first movable contact in at least a first coupling position (A) and a second coupling position (B) which are spaced apart, and wherein at least one of said second fixed contact and second movable contact has a shape for coupling said second fixed contact with the second movable contact in at least a third coupling position (C) and a fourth coupling position (D) which are spaced apart.

### BRIEF DESCRIPTION OF THE DRAWINGS

Further characteristics and advantages will become apparent from the description of some preferred but not exclusive exemplary embodiments of a HV switching device according to the present disclosure, illustrated only by way of non-limitative examples with the accompanying drawings, wherein:

FIG. 1 is a perspective view of a HV switching device configured as a disconnector according to an exemplary embodiment of the present disclosure;

FIG. 2 is a perspective view of a HV switching device configured as a combined disconnector-earthing switch device according to an exemplary embodiment of the present disclosure;

FIG. 3 is a perspective view of movable contacts used in a HV switching device according to an exemplary embodiment of the present disclosure;

FIG. 4 is a perspective view showing a fixed contact used in a HV switching device according to an exemplary embodiment of the present disclosure;

FIG. 5 is a cross section of the HV switching device according to an exemplary embodiment of the present disclosure;

FIGS. 6-9 schematically show, in sequence, a plurality of possible different positions of the switching device of FIG. 2 according to an exemplary embodiment of the present disclosure; and

FIG. 10 schematically shows a hybrid switchgear including a switching device according to an exemplary embodiment of the present disclosure.

### DETAILED DESCRIPTION

It should be noted that in the detailed description that follows, identical or similar components, either from a structural and/or functional point of view, have the same reference numerals, regardless of whether they are shown in different exemplary embodiments of the present disclosure; it should also be noted that in order to clearly and concisely describe the present disclosure, the drawings are representative and may not be to scale and certain features of the disclosure may be shown in somewhat schematic form.

Further, when the term “adapted” or “arranged” or “configured” or “shaped”, is used herein while referring to any component as a whole, or to any part of a component, or to a whole combinations of components, or even to any part of a combination of components, it has to be understood that it means and encompasses correspondingly either the structure, and/or configuration and/or form and/or positioning of the related component or part thereof, or combinations of components or part thereof, such term refers to.

Exemplary embodiments of the present disclosure are directed to fulfilling the aforementioned specifications and providing a high voltage (HV) switching device including a casing containing at least a first fixed contact and a second fixed contact which are positioned spaced apart from each other and are suitable to be connected to two corresponding power terminals, a first movable contact and a second movable contact which are spaced apart from each other and can be actuated so as to couple with said first fixed contact and said second fixed contact, respectively, wherein at least one of said first fixed contact and first movable contact has a respective body shaped so as the first movable contact can couple with said first fixed contact in at least a first coupling position and in a second coupling position which are spaced apart from each other, and wherein at least one of said second fixed contact and second movable contact has a respective body shaped so as the second movable contact can couple with said second fixed contact in at least a third coupling position and a fourth coupling position which are spaced apart from each other.

Finally, the HV switching device of the present disclosure can be used in a gas-insulated or hybrid switchgear, e.g. of the type marketed by the ABB® group under the commercial name of PASS™, and it will be described by making reference to its application in such a type of switchgear without intending in any way to limit its possible scope of applications as a stand-alone device or in combination with other types of electrical switchgear or devices.

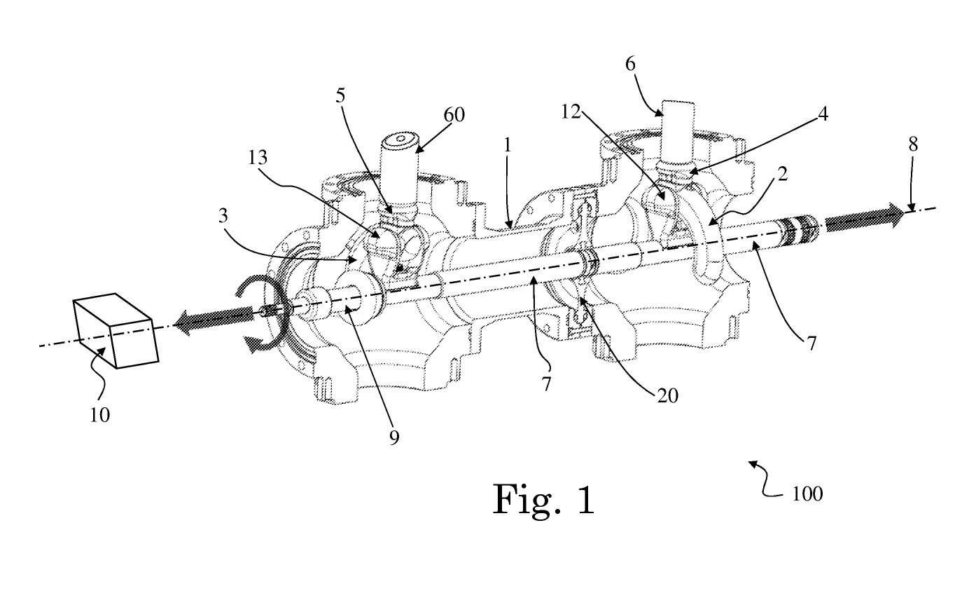

FIG. 1 is a perspective view of a HV switching device configured as a disconnector according to an exemplary embodiment of the present disclosure.

As shown in FIG. 1, the high voltage (“HV”) switching device 100 includes a casing 1 which can be constituted by a single part, or as illustrated in FIG. 1, the switching device 100 can include two or more parts mechanically connected to each other. The casing 1 has at least a first fixed contact 2 and a second fixed contact 3 which are positioned spaced apart from each other and are suitable to be connected to two corresponding power connection terminals 4, 5 for realizing input/output connections into/out from the device 100 itself.

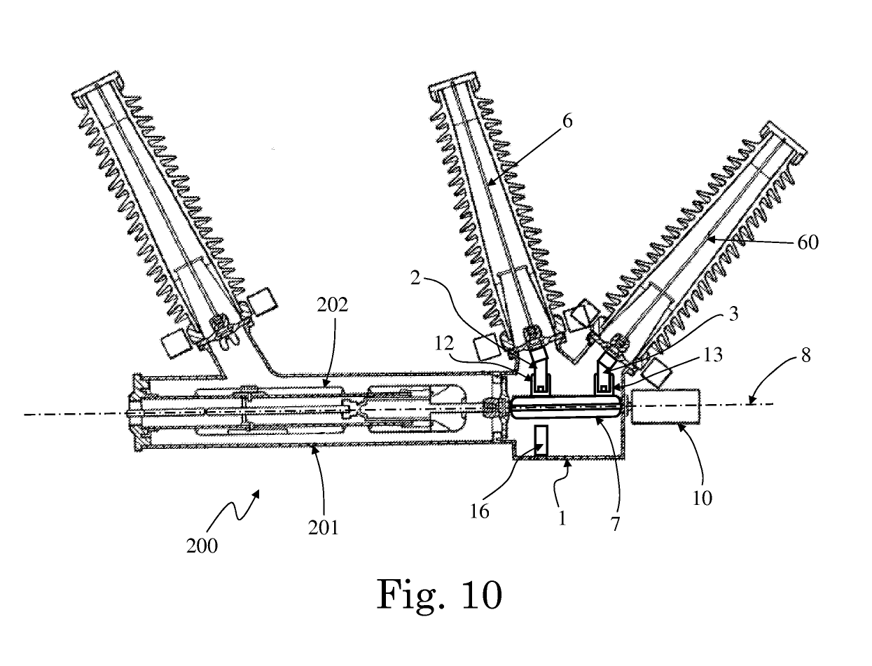

For example, the first and second fixed contacts 2-3, by means of the respectively associated first power connection terminal 4 and second power connection terminal 5, can be electrically connected in input to and output from the device 100 with a phase of an electrical line, respectively, for example using corresponding cables, or rods, or bars 6, 60 as schematically shown in the Figures and for example in FIG. 10. Alternatively, the first connection terminal 4 (and associated first fixed contact 2) can be connected in input from an electrical line and the second terminal 5 (and associated second fixed contact 3) can be connected in output towards a power or distribution transformer, respectively; however, other connections can be realized according to the various possible applications.

Inside the casing 1 there are also provided a first movable contact 12 and a second movable contact 13 which are spaced apart from each other and can be actuated simultaneously by suitable actuation means so as to electrically couple with the first fixed contact 2 and the second fixed contact 3, respectively.

According to an exemplary embodiment of the present disclosure, in the switching device 100, at least one of the first fixed contact 2 and the first movable contact 12 has a respective body shaped so that the first movable contact 12, when actuated, engages/couples with the first fixed contact 2 in at least a first coupling position (A) and in a second coupling position (B) which are spaced apart from each other; further, at least one of the second fixed contact 3 and the second movable contact 13 has a respective body shaped so that the second movable contact 13, when actuated together with the first movable 12 contact, engages/couples with said second fixed contact 3 in at least a third coupling position (C) and a fourth coupling position (D) which are spaced apart from each other.

As it will be described more in detail hereinafter, in the exemplary switching device 100 disclosed herein, at least one of the first fixed contact 2 and first movable contact 12 has a respective body shaped so that the first movable contact 12, when actuated couples/engages with the first fixed contact 2 in at least a first coupling position (A) and in a second coupling position (B) which are angularly spaced from each other; at such coupling positions the first movable contact 12 is still and electrically coupled with the first fixed contact 2. Further at least one of the second fixed contact 3 and second movable contact 13 has a respective body shaped so that the second movable contact 13, when actuated together with the first movable contact 12, couples/engages with the second fixed contact 13 in at least a third coupling position (C) and a fourth coupling position (D) which are angularly spaced apart from each other; at such third and fourth coupling positions the second movable contact 13 is still and electrically coupled with the second fixed contact 3.

According to an exemplary embodiment of the present disclosure, and with respect to the rotation axis 8, one of the first or second couplings positions (A) (B) of the first fixed contact 2 with the first movable contact 12 is angularly substantially coincident with one of the third or fourth coupling positions (C) (D) of the second fixed contact 3 with the second movable contact 13.

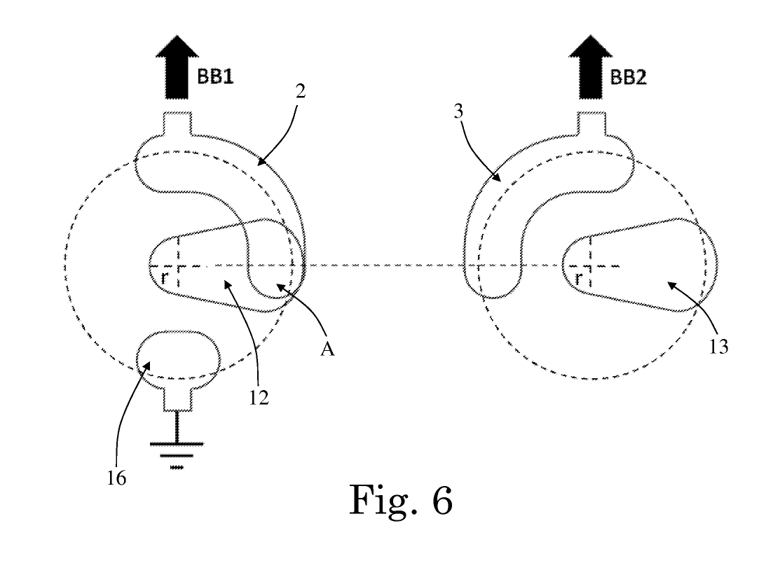

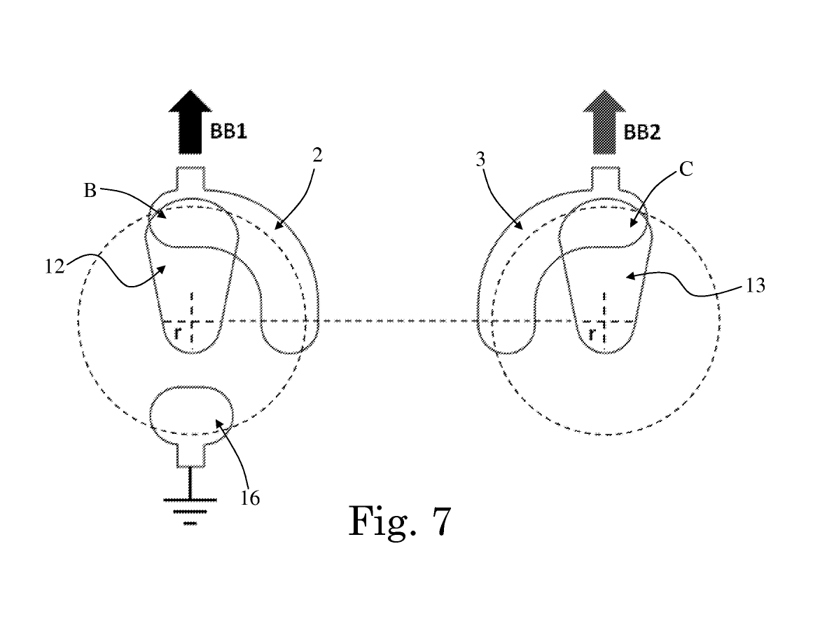

For example, as illustrated in FIGS. 6 and 7, the first movable contact 12 and the first fixed contact 2 couple together in two predefined couplings positions (A) and (B) which are angularly spaced from each other as desired, and preferably at about 90°.

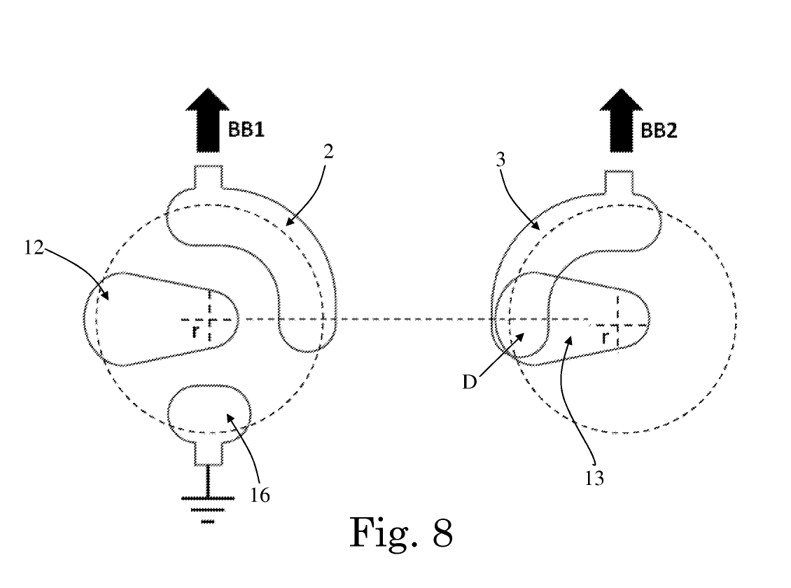

Likewise, as illustrated in FIGS. 7 and 8, the second movable contact 13 and the second fixed contact 3 couple together in two predefined couplings positions (C) and (D) which are angularly spaced from each other as desired, and preferably at about 90°.

In accordance with the exemplary embodiments of the present disclosure, and as visible from FIG. 7, the coupling position (B) between the first fixed and movable contacts 2, 12 is angularly coincident with the coupling position (C) between the second fixed and movable contacts 3, 13.

According to another exemplary embodiment of the present disclosure, the first movable contact 12 and the second movable contact 13 are mounted on and solidly move together with an actuation element 7.

For example, the actuation element 7 is placed inside the casing 1 rotating about a reference axis 8.

In practice, the actuating element 7 rotates around the reference rotation axis 8 with the moving contacts 12 and 13 which rotate simultaneously to each other and solidly together with the actuation element 7; in turn, the first fixed contact 2 is positioned on the rotation path of the first movable contact 12 and the second fixed contact 3 is positioned on the rotation path of the second movable contact 13.

Accordingly, the predefined first and second coupling positions (A) and (B) are angularly spaced from each other along the rotation path of the first movable contact 12, and the predefined third and fourth coupling positions (C) and (D) are angularly spaced from each other along the rotation path of the second movable contact 13.

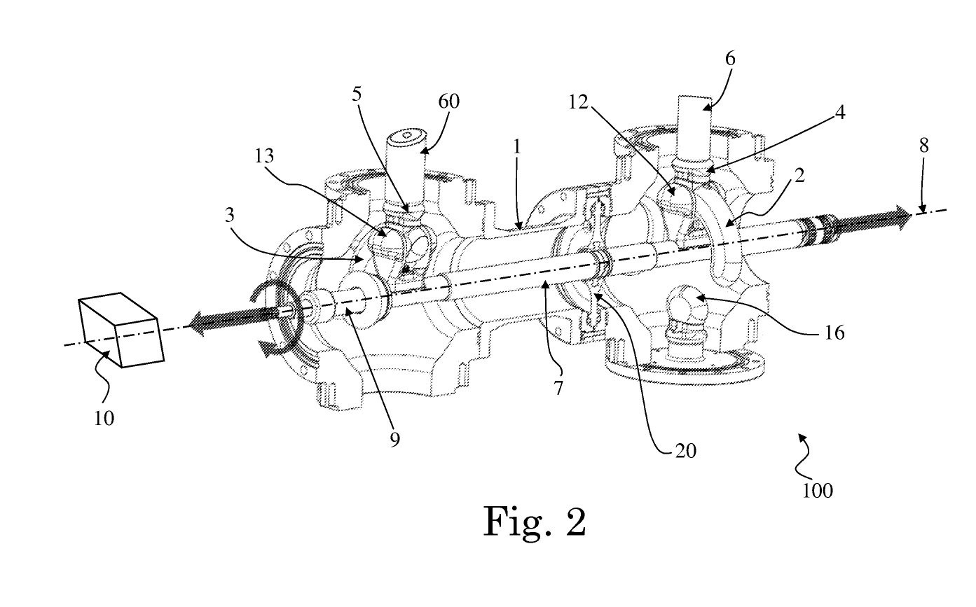

The actuation element 7 can be constituted for example by a rod or shaft 7 which can be formed by one single piece, as for example illustrated in FIG. 10, or by two or more pieces connected together as for example illustrated in FIGS. 1 and 2.

One end of the rotating actuation element 7 is operatively connected, e.g. by means of an insulating rod 9, to actuation means including for example an electric motor 10 which is positioned outside the casing 1 and supplies the energy specified to rotate the actuating element 7 and the contacts 12, 13 solidly connected therewith; the other end of the actuation element 7 can be connected to one side of the casing 1, e.g. by means of bearings, when the device 100 is used as a stand-alone component, or it can be connected operatively to other elements in case the switching device 100 is associated to or used in more complex switchgear devices. For example, in the embodiment illustrated in FIG. 10, the exemplary switching device 100 is a component of a hybrid switchgear 200 wherein the casing 1 is connected to a further casing 201 housing for example a circuit breaker 202. In this case the end of the actuating element 7 is operatively connected to such a circuit breaker 202.

According to exemplary embodiments of the present disclosure, when the device 100 is seen in cross-section (namely a plane perpendicular to the reference rotation axis 8), the first movable contact 12 and the second movable contact 13 are mounted on the actuating element 7 substantially aligned to each other along the reference axis 8.

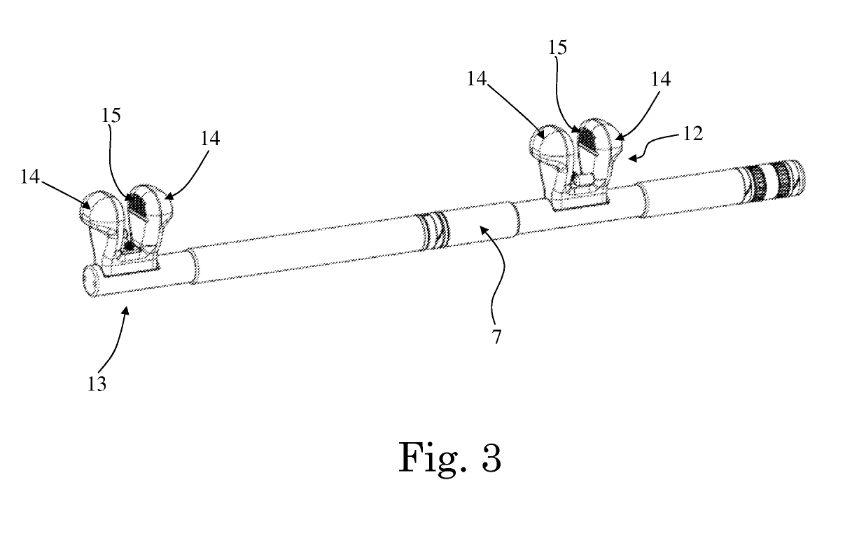

FIG. 3 is a perspective view of movable contacts used in a HV switching device according to an exemplary embodiment of the present disclosure. As illustrated in FIG. 3, the first movable contact 12 and the second movable contact 13 include a body having a U-shape or gripper-shape; the internal surfaces of the lateral facing sides 14 of the U-shaped or gripper-shaped body are provided with contact reeds or strips 15 suitable to electrically match with corresponding parts of the fixed contacts 2, 3 at the respective predefined coupling regions (A) or (B), and (C) or (D).

The two movable contacts 12, 13, may not be identical to each other; however, according to exemplary embodiments described herein, the two movable contacts 12 and 13 can be substantially identical to each other. In this way, manufacturing costs can be optimized.

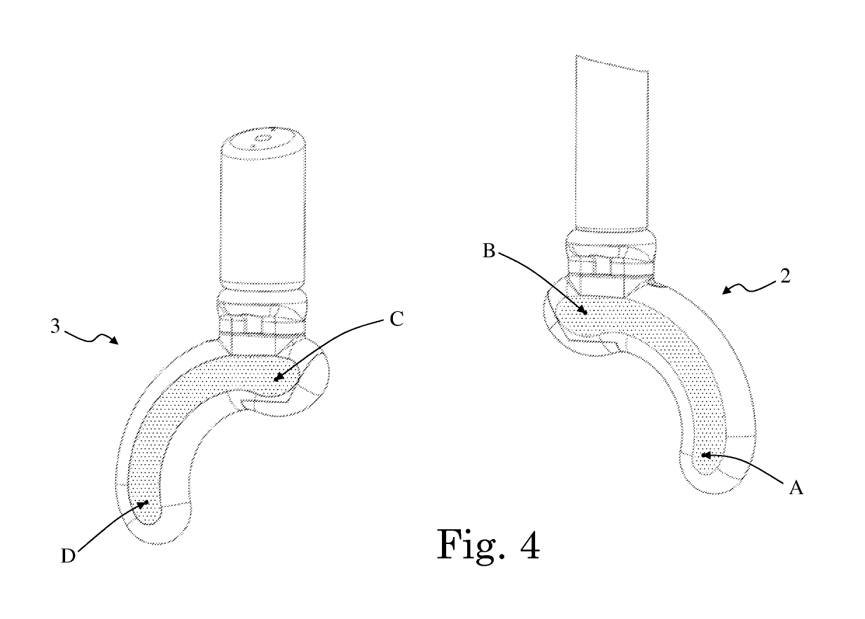

As illustrated in the exemplary Figures, the first fixed contact 2 includes a body having a curved-blade shape extending for a certain angular sector, e.g. of about 90° or more. FIG. 4 is a perspective view showing a fixed contact used in a HV switching device according to an exemplary embodiment of the present disclosure. As shown in FIG. 4, the external side surfaces of the curved-blade body of the first fixed contact 2 are silver-plated at least at the regions of its body defining and corresponding to the first and second coupling positions (A), (B). In the exemplary embodiment illustrated in FIG. 4, the entire surface from the coupling region (A) to the coupling region (B) is silver-plated on both sides, namely an arc of at least about 90° is covered, on the side surfaces, with silver plates; in this way, while moving, the first movable contact 12 touches a useful and continuous electrical contact surface of about 90° on the first fixed contact 2 between the two predefined coupling positions (A), (B), at which the first movable contact 12 stops and remains still and electrically connected to the first fixed contact 2.

Clearly, it is possible for example to limit the use of coating silver plates just at the regions of the predefined coupling positions (A), (B) while the external side surfaces of the curved blade in between such coupling regions/positions (A)(B) can be left uncoated.

It is even possible to have the regions at the coupling regions/positions (A), (B) thicker than the central part interconnecting the two coupling regions; in this way, the first movable contact 12, when rotating, touches and engages with the first fixed contact 2 only at the predefined coupling regions (A) and (B).

In turn, also the second fixed contact 3 includes a body having a curved-blade shape extending for a certain angular sector, e.g. of about 90° or more; as for the first fixed contact 2, also the external side surfaces of the curved-blade body of the second fixed contact 3 are silver-plated at least at the regions defining and corresponding to the third and fourth coupling positions (C), (D). According to an exemplary embodiment of the present disclosure, the entire surface from the coupling region (C) to the coupling region (D) is silver-plated on both sides, namely an arc of at least about 90° is covered, on the side surfaces, with silver plates; hence, while moving, the second movable contact 13 touches a useful and continuous electrical contact surface of about 90° on the second fixed contact 3 between the two predefined coupling positions (A), (B), at which the second movable contact 13 stops and remains still and electrically connected to the second fixed contact 3.

Clearly, also for the second fixed contact 3 it is possible to limit the use of coating silver plates just at the regions of the predefined coupling regions/positions (C), (D) while the external side surfaces of the curved blade in between such coupling positions (C)(D) can be left uncoated.

Also in this case it is even possible to have the regions at the coupling regions/positions (C), (D) thicker than the central part interconnecting such two coupling regions; in this way, the second movable contact 13, when rotating, touches and engages with the second fixed contact 3 only at the predefined coupling regions (C) and (D).

According to an exemplary embodiment disclosed herein, the first and second fixed contacts 2, 3 are mounted inside the casing 1 opposite to each other with respect to said reference axis 8. In another exemplary embodiment of the present disclosure, the first and second fixed contacts 2, 3 are substantially identical to each other so the exemplary embodiment illustrated to FIG. 4 can be applied to both fixed contacts 2, 3.

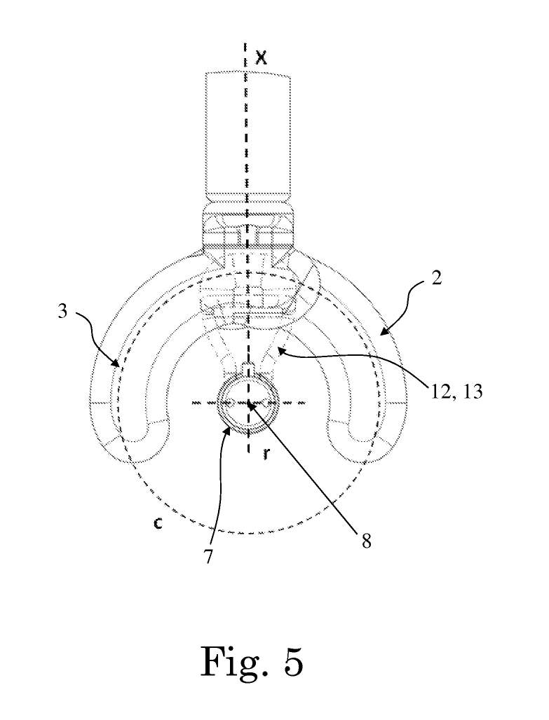

FIG. 5 is a cross section of the HV switching device according to an exemplary embodiment of the present disclosure. As shown in FIG. 5, for example, the fixed contacts 2, 3 are mirror-positioned to each other with respect to a vertical plane X containing the rotation axis.

FIG. 2 is a perspective view of a HV switching device configured as a combined disconnector-earthing switch device according to an exemplary embodiment of the present disclosure. As shown in FIG. 2, the switching device 100 includes, in addition to all elements previously described for the exemplary embodiment of FIG. 1, a further fixed contact, namely, an earthing fixed contact 16 for connection to ground potential; in this way, the switching device 100 assumes the configuration of a combined disconnector-earthing switch device.

In the exemplary embodiment illustrated, the earthing contact 16 is placed inside the casing 1 along the rotation path of the first movable contact 12 and at a position such that the first movable contact 12 cannot simultaneously couple with the first fixed contact 2 and the earthing fixed contact 16.

The operations of a switching device 100 according to the present disclosure will be now briefly described with reference to its exemplary embodiment of FIG. 2.

FIGS. 6-9 schematically show, in sequence, a plurality of possible different positions of the switching device of FIG. 2 according to an exemplary embodiment of the present disclosure. For example, FIG. 6 schematically represents an operative condition where the first moving contact 12 is engaged with the first fixed contact 2 in the coupling position (A) and the second movable contact 13 is disconnected from the corresponding second fixed contact 3; in this condition, for example the first bus bar 6 is electrically connected (in input or output) with the device 100 while the second bus bar 60 is disconnected. If the electric motor 10 actuates the actuation element 7 to rotate, e.g. of 90° degrees counterclockwise, the movable contacts 12, 13 rotate rigidly therewith and the first movable contact 12 stops and engages the first fixed contact 2 at the predefined second coupling position (B), while the second movable contact 13 stops and engages the second fixed contact 2 at the predefined third coupling position (C), as illustrated in FIG. 7. In this position, for example both bus bars 6 and 60 are electrically connected (in input or output) with the switching device 100.

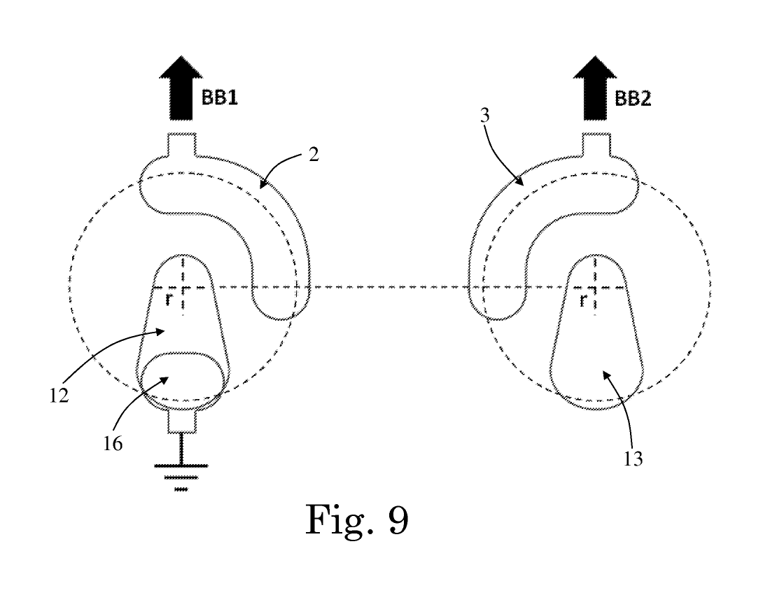

From this position, by further rotating the actuation element 7, e.g. of additional 90° degrees counterclockwise, the first movable contact 12 is disconnected from the first fixed contact 2, while the second movable contact 13 stops and engages with the second fixed contact 3 at the predetermined fourth coupling position (D), as shown in FIG. 8. In this position, for example the first bus bar 6 is disconnected while the second bus bar 60 is electrically connected (in input or output) with the device 100. A further rotation of 90° counterclockwise of the actuation element 7 brings the first movable contact 12 to stop and engage the earthing fixed contact 16 which is at ground potential, while the second movable contact is disconnected from the second fixed contact 3, as illustrated in FIG. 9. In this position, for example both bus bars 6, 60, are disconnected and the device 100 is connected to ground potential.

It has been found that the switching device 100 according to the present disclosure offers some improvements over prior art solutions; indeed, thanks to the exemplary embodiments previously described, and for example due to the configuration and mutual position of its various elements and the various contacts, the switching device 100 as a whole is more compact if compared to known devices of equivalent rate and performances. Indeed, in the exemplary switching device 100 according to the present disclosure each operative position is angularly spaced from the adjacent ones (following and preceding) of about 90°, thus allowing a decrease in the diameter or maximum external size of the casing 1, while keeping the specified dielectric clearances.

Such results are achieved because of a solution which in principle makes the switching device 100 according to the present disclosure easy to be used in connection with different types of electric substations or switchgear combining more electrical devices.

Hence, the present disclosure also encompasses an electric substation or switchgear wherein it includes a high voltage switching device 100 of the type previously described and as defined in the appended claims.

The HV switching device 100 according to exemplary embodiments of the present disclosure is susceptible of modifications and variations, all of which are within the scope of the exemplary embodiments as defined for example by the appended claims; any possible combination of the previously disclosed exemplary embodiments/alternatives can be implemented and has to be considered within the broad concept of the present disclosure; all the details may furthermore be replaced with technically equivalent elements. For example, the casing 1 can be separated in two parts segregated from each other by means of an insulating disc 20 partially illustrated in FIGS. 1 and 2. The switching device 100 can be of the single-pole actuation type in which there are actuation means on each individual phase in order to perform the disconnection operation; as an alternative, the device can be of the three-pole actuation type, in which the energy for performing the disconnection operation on the three phases of the device is supplied by a single motor which is mechanically coupled to the disconnection units of each individual phase.

Any of the previously described components can be differently shaped, or used in a different number or parts or elements, or the components previously described can be differently connected with respect to each other, provided they are suitable for the scope they are devised for. For example, the electric motor 10 can be replaced by any suitable drive or it is possible to use mechanical or hydraulic actuation means, or the terminals 4 and 5 can be realized integral with the associated fixed contacts 2, 3. Manual actuation means can also be provided as an alternative, or as an addition, to the above described actuation means. The silver plates suitable to couple with the reeds or strips 15 can be made of a different material or the reeds or strips 15 themselves can be differently shaped.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A high voltage switching device, comprising:
a casing including at least a first fixed contact and a second fixed contact which are spaced apart and are configured to be connected to two corresponding power terminals;
a first movable contact and a second movable contact which are spaced apart and configured to be actuated for coupling with said first fixed contact and said second fixed contact, respectively,
wherein at least one of said first fixed contact and first movable contact has a shape for coupling said first fixed contact with the first movable contact in at least a first coupling position and a second coupling position which are spaced apart, and
wherein at least one of said second fixed contact and second movable contact has a shape for coupling said second fixed contact with the second movable contact in at least a third coupling position and a fourth coupling position which are spaced apart.

2. The switching device according to claim 1, wherein the shape of at least one of said first fixed contact and first movable contact allows the first movable contact to be coupled with said first fixed contact in at least the first coupling position and in the second coupling position which are angularly spaced, and
wherein the shape of at least one of said second fixed contact and second movable contact allows the second movable contact to be coupled with said second fixed contact in at least a third coupling position and a fourth coupling position which are angularly spaced apart.

3. The switching device according to claim 2, wherein said first movable contact and said second movable contact are mounted on and move together with an actuation element, said actuating element being placed inside said casing and rotates about a reference axis, and wherein said first fixed contact is positioned on a rotation path of said first movable contact and said second fixed contact is positioned on a rotation path of said second movable contact, said first and second coupling positions being angularly spaced along said rotation path of the first movable contact, and said third and fourth coupling positions being angularly spaced along said rotation path of the second movable contact.

4. The switching device according to claim 3, wherein, with respect to said reference axis, one of the first or second couplings positions of the first fixed contact with the first movable contact is angularly coincident with one of the third or fourth coupling positions of the second fixed contact with the second movable contact.

5. The switching device according to claim 3, wherein said first movable contact and said second movable contact are mounted on said actuating element substantially aligned to each other along said reference axis.

6. The switching device according to claim 1, wherein said first and second movable contacts include a body having a U- or gripper shape whose internal surfaces of its facing sides are provided with contact reeds or strips.

7. The switching device according to claim 1, wherein said first movable contact and said second movable contact are substantially identical to each other.

8. The switching device according to claim 1, wherein said first fixed contact includes a body having a curved-blade shape.

9. The switching device according to claim 8, wherein the external surfaces of said curved-blade body of the first fixed contact are silver-plated at least at regions corresponding to said first and second coupling positions.

10. The switching device according to claim 1, wherein said second fixed contact includes a body having a curved blade shape.

11. The switching device according to claim 10, wherein the external surfaces of said curved-blade body of the second fixed contact are silver-plated at least at regions corresponding to said third and fourth coupling positions.

12. The switching device according to claim 1, wherein said first and second fixed contacts are substantially identical and positioned as mirror images to each other with respect to a reference vertical plane containing said reference axis.

13. The switching device according to claim 1, comprising:
an earthing fixed contact for connection to ground potential which is positioned inside said casing on a path of said first movable contact and at a position such that said first movable contact cannot simultaneously couple with said first fixed contact and said earthing fixed contact.

14. An electric substation, comprising at least one high voltage switching device according to claim 1.

15. An electric switchgear, comprising a high voltage switching device according to claim 1.
